(19) United States
(12) Patent Application Publication
(10) Pub. No.: US 2022/0009264 A1
(43) Pub. Date: Jan. 13, 2022

(54) MECHANISM TO DYNAMICALLY ADJUST DRYER PERFORMANCE

(71) Applicants: Scott Richard Johnson, Erie, CO (US); Stuart James Boland, Denver, CO (US)

(72) Inventors: Scott Richard Johnson, Erie, CO (US); Stuart James Boland, Denver, CO (US)

(73) Assignee: Ricoh Company, Ltd., Tokyo (JP)

(21) Appl. No.: 17/482,570

(22) Filed: Sep. 23, 2021

Related U.S. Application Data
(62) Division of application No. 15/867,819, filed on Jan. 11, 2018.

(51) Int. Cl. B41M 7/00; B41J 2/01; B41J 11/00

(52) U.S. Cl. CPC B41M 7/009; B41J 11/002; B41J 2/01

(57) ABSTRACT

A printing system is disclosed. The printing system includes a print controller and an engine controller to receive printing characteristic information from the print controller, determine one or more dryer control parameters based on the printing characteristic information and update the one or more dryer control parameters upon detecting one or more printing characteristic information changes during a printing process.

### PRIORITY

The present patent application is a Divisional application claiming priority from U.S. application Ser. No. 15/867,819, filed Jan. 11, 2018, which is currently pending.

### FIELD OF THE INVENTION

The invention relates to the field of production printing systems, and in particular, to the handling of print media.

### BACKGROUND

Entities with substantial printing demands typically implement a high-speed production printer for volume printing (e.g., one hundred pages per minute or more). Production printers include continuous-forms printers that print ink or toner on a web of print media stored on a large roll. An ink jet production printer typically includes a localized print controller that controls the overall operation of the printing system, and a print engine that includes one or more printhead assemblies, where each assembly includes a printhead controller and a printhead (or array of printheads). An individual ink jet printhead typically includes multiple tiny nozzles that discharge ink as controlled by the printhead controller. A printhead array is formed from multiple printheads that are spaced in series across the width of the web of print media.

While the ink jet printer prints, the web is quickly passed underneath the nozzles, which discharge ink onto the web at intervals to form pixels. A dryer, installed downstream from the printer, may assist in drying the wet ink on the web after the web leaves the printer. Handling the web can prove challenging due to variation of a number of factors. For instance, high web speeds, varying ink discharge amounts, and wide variation of paper types may cause a high variation in temperature control, which often results in a large amount of user interaction (e.g. adjusting setpoints) to maintain proper drying performance. Improper drying control may result in an output web that is over dried (e.g. charred or curled), under dried (e.g. wet, smeared or contaminated) or processed at non-optimal web speeds.

Accordingly, a mechanism to dynamically adjust dryer performance in a printing system during printing is desired.

### SUMMARY

In one embodiment, a printing system is disclosed that includes a print controller, and an engine controller to receive printing characteristic information from the print controller, determine one or more dryer control parameters based on the printing characteristic information and update the one or more dryer control parameters upon detecting one or more printing characteristic information changes during a printing process.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a drying system;

FIG. 3 illustrates one embodiment of a printer;

FIG. 4 is a flow diagram illustrating one embodiment of a process for dynamically adjusting dryer performance in a printing system; and

FIG. 5 illustrates a computing device suitable for implementing embodiments of the present disclosure.

### DETAILED DESCRIPTION

A mechanism to dynamically adjust dryer settings in a printing system during printing is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

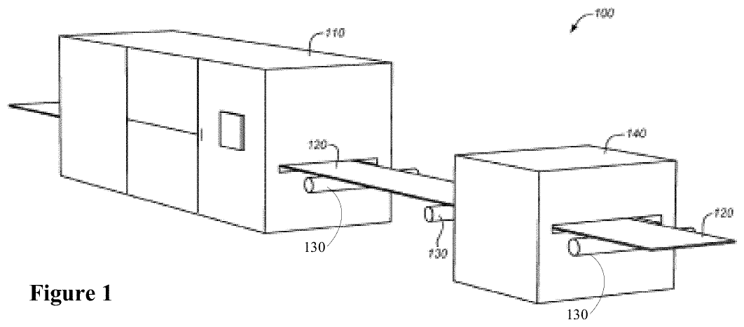

FIG. 1 illustrates one embodiment of a printing system 100. Printing system 100 includes production printer 110, which is configured to apply ink onto a web 120 of continuous-form print media (e.g., paper, textiles and other printable substrates). As used herein, the word “ink” is used to refer to any suitable marking material (e.g., aqueous based inks, solvent based inks, UV curable inks, clear inks, oil-based paints, toners, etc.). Printer 110 may include an inkjet printer (e.g. drop on demand or continuous flow) that applies colored inks, such as Cyan (C), Magenta (M), Yellow (Y), Key (K) black, white, or clear inks. The ink applied by printer 110 to the web 120 is wet. Thus, the ink may smear if not dried before further processing. Additionally, one or more rollers 130 position web 120 as it travels through, into or out of printer 110.

To dry ink, printing system 100 also includes drying system 140 (e.g., a radiant heat dryer, a convection heat dryer, a conductive heat dryer or any combinations thereof). Thus, web 120 travels through drying system 140 to dry the ink onto web 120. In one embodiment, drying system 140 is a physically separate device downstream from printer 110. However, embodiments may feature drying system 140 being incorporated within printer 110.

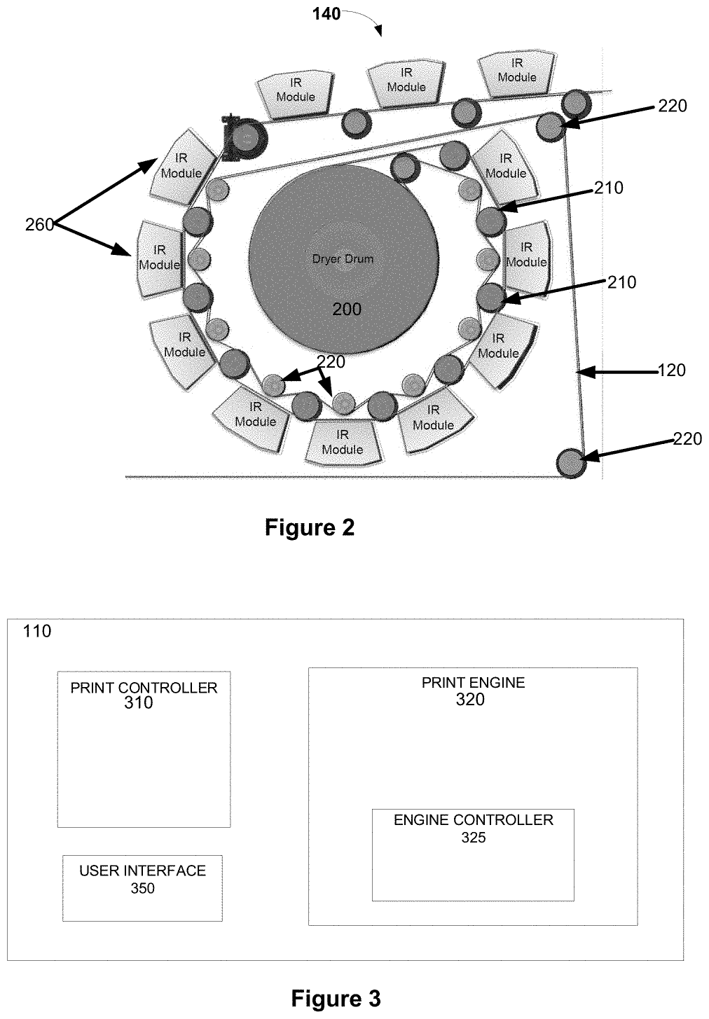

FIG. 2 illustrates one embodiment of a drying system 140. As shown in FIG. 2 drying system 140 includes dryer drum 200, conductive rollers 210 and idle rollers 220, which facilitate a path of web 120 to traverse through drying system 140. In one embodiment, dryer drum 200 is a high temperature, heated, thermally conductive drum that is implemented, along with conductive rollers 210 (e.g. heated thermally conductive rollers), to dry web 120. Idle rollers 220 position web 120 as it travels through, into or out of drying system 140.

Drying system also includes a plurality of infrared (IR) modules 260 that are implemented to provide direct radiation and airflow to web 120. In one embodiment, one or more of the IR modules 260 may include sensors to measure the temperature and airflow applied to web 120. In a further embodiment, one or more conductive rollers 210, drum roller 200 or other structures within dryer 140 may also include such sensors.

Although discussed as a drying system, embodiments may feature implementation of system 140 as an independent web-handling device downstream from printer 110. Further embodiments may feature a web-handling system being incorporated within printer 110. In such embodiments, web 120 travels through the web handling system to be buffered, tensioned, cooled, wound, unwound, aligned, cut, slit, punched or perforated.

As discussed above, high web speeds, varying printed ink coverage and medium type variations may result in a disparity in temperature control, drying consistency and overall drying performance at drying system 140, typically requiring a high magnitude of user interaction to maintain proper drying performance. According to one embodiment, printer 110 may be configured to dynamically set control parameters and adjust settings and print speed settings within drying system 140 as the changes occur during printing to the web.

FIG. 3 illustrates one embodiment of a printer 110, which includes a print controller 310 and print engine 320. Print controller 310 (e.g., digital front end or DFE) processes received sheet images (e.g. print data) to generate a bitmap that is to be transmitted for printing (e.g. applying marking material) to a web 120 of print medium via print engine 320. Thus, print controller 310 may be any system, device, software, circuitry and/or other suitable component operable to transform the sheet image for generating the bitmap in accordance with printing onto the print medium. In this regard, the print controller 140 may include processing and data storage capabilities.

Print engine 320 subsequently applies the ink onto the print medium based on the bitmap. According to one embodiment, print engine 320 includes an engine controller 325 that is communicatively coupled to drying system 140, and receives printing characteristic information from printer controller 310 and dynamically adjusts control parameters and settings in drying system 140 during printing. In such an embodiment, the printing characteristic information may include print job information, print system settings and system configuration information. In one embodiment, print job information may include information regarding printed ink coverage, ink type, ink colors, tone curve, etc., while print system settings may include information regarding print speed and page settings (e.g., duplex). Additionally, system configuration information may include information related to print medium type, printer type/features, dryer type/features, environment (e.g. measured temperature, airflow, humidity), etc. In one embodiment, engine controller 325 and print controller 310 may be the same controller.

Upon receiving the printing characteristic information, engine controller 325 may determine print speed and dryer settings. According to one embodiment, engine controller 325 implements a predictive model to select an optimum dryer setting based on a target print speed included in the printing characteristic information. Dryer settings may include one or more target operating temperatures, power input, airflow, etc. Additionally, dryer settings may include powering off selected dryer components while others remain on and under control.

In other embodiments, engine controller 325 may optimize print speed and dryer settings upon a determination that the target print speed is not achievable for proper dryer performance based on the printing characteristic information. For instance, engine controller 325 may determine that the target print speed exceeds a print speed that would enable adequate drying of ink on the medium (e.g., maximum drying print speed) to provide quality printing. In such an embodiment, engine controller 325 calculates the print speed and dryer settings to optimize print quality.

In a further embodiment, engine controller 325 may receive system operator (or user) setting preferences via a user interface 350 included in printer 110. In this embodiment, the operator settings preferences may include a speed versus quality indication that facilitates the print speed and dryer settings selection. Although discussed above with reference to implementation of a predictive model, other embodiments of engine controller 325 may implement other mechanisms (e.g., one or more predefined lookup tables (LUTs) to perform speed, settings and parameter calculations.

According to one embodiment, engine controller 325 determines (or calculates) one or more dryer control parameters based on the selected settings. Once the dryer control parameters are calculated, engine controller 325 initiates the printing and drying process according to the calculated settings and parameters. In one embodiment, the parameters may include tuning (e.g., feedback gain) parameters for implementation of a control loop feedback mechanism to dynamically adjust dryer control during printing within system 100. In such an embodiment, engine controller 325 may implement one or more proportional-integral-derivative (PID) controllers with the PID inputs implementing a dryer control setpoint (e.g. target temperature setting), a measured system parameter (e.g. sensor temperature), and the PID output controlling the dryer system active elements (e.g., airflow, radiant energy, conductive energy, etc.). In that embodiment, the feedback gain parameters include a proportional gain, an integral gain and a derivative gain values. However other embodiments may implement other types of control systems.

During printing and drying, engine controller 325 monitors printing system 100. In this embodiment, engine controller 325 monitors the system for changes to one or more characteristics (e.g., temperature, airflow, etc.) included in the printing characteristic information. Such characteristics may be monitored by interpreting data received from sensors, such as those discussed above with reference to drying system 140. In further embodiments, engine controller 325 may receive printing characteristic information changes from a system operator via user interface 350.

According to one embodiment, engine controller 325 determines/calculates updated printer speed settings, dryer settings and dryer control parameters in response to detecting one or more changes within the system and/or input from user interface 350. Further, engine controller 325 continues to monitor the system once the settings and parameters have been updated. Thus, engine controller 325 dynamically updates control parameters and/or settings to adjust drying control and printing speed upon detecting system changes until printing has been completed.

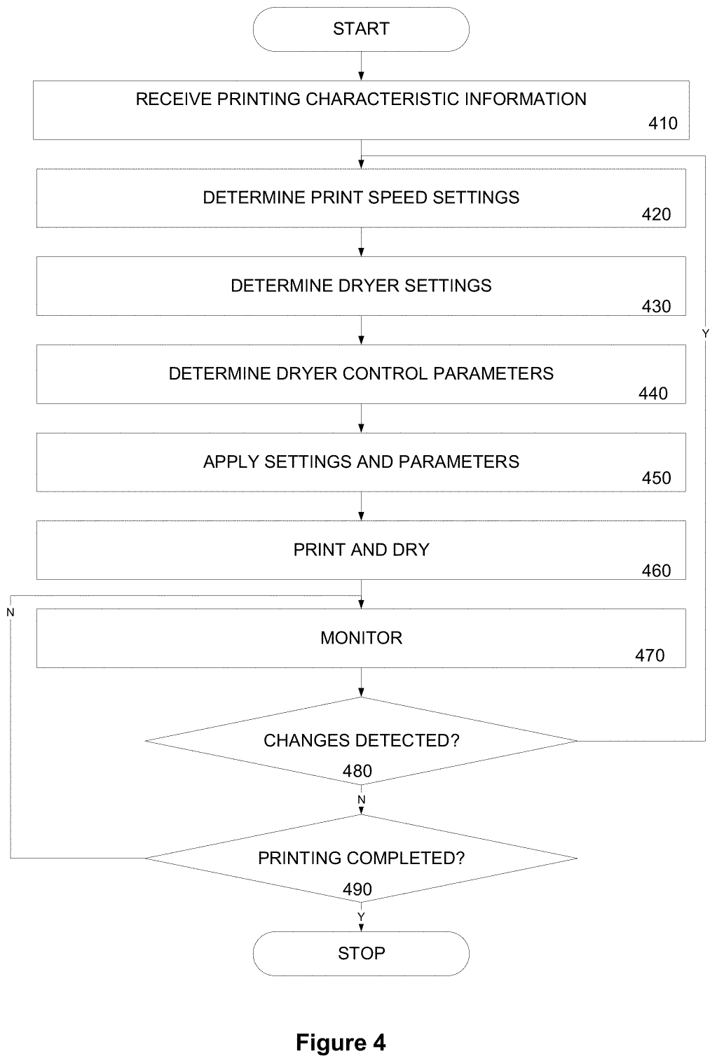

FIG. 4 is a flow diagram illustrating one embodiment of a process for dynamically adjusting dryer settings in a printing system. At processing block 410, printing characteristic information is received at engine controller 325 from print controller 310. At processing block 420, the print speed settings are determined based on the received printing characteristic information. As discussed above, the print speed settings may be calculated based on a maximum drying print speed. However, processing block 420 may be optional in embodiments in which print speed is pre-set and/or fixed.

At processing block 430, the dryer settings are calculated based on the printing characteristic information. At processing block 440, the dryer control parameters are calculated based on the dryer settings. At processing block 450, the dryer control parameters are applied to drying system 140. At processing block 460, the printing process at printing system 100 is initiated to apply ink to a medium according to the bitmap and dry the ink applied to the medium at the dryer. At processing block 470, printing system 100 is monitored for changes to the printing characteristic information during printing and drying. In one embodiment, the changes are determined based on comparing printing characteristic information received at processing block 410 with printing characteristic information received at processing block 470.

At decision block 480, a determination is made as to whether one or more changes to the printing characteristic information has been detected. If a determination is made that changes have been detected, control is returned to processing blocks 420-470, where updated print speed settings, dryer settings and/or control parameters are determined and applied to the printer and/or dryer during the printing process prior to continued monitoring.

If at decision block 480 a determination is made that changes have not been detected, a determination is made as to whether the printing process has been completed, decision block 490. Control is returned to processing block 470 for continued system monitoring upon a determination that printing has not been completed. Otherwise, the process has been completed.

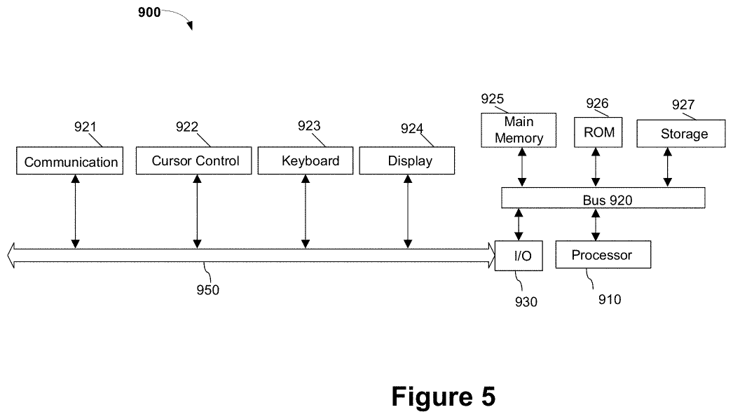

FIG. 5 illustrates a computer system 900 on which print controller 310 and/or engine controller 325 may be implemented. Computer system 900 includes a system bus 920 for communicating information, and a processor 910 coupled to bus 920 for processing information.

Computer system 900 further comprises a random access memory (RAM) or other dynamic storage device 925 (referred to herein as main memory), coupled to bus 920 for storing information and instructions to be executed by processor 910. Main memory 925 also may be used for storing temporary variables or other intermediate information during execution of instructions by processor 910. Computer system 900 also may include a read only memory (ROM) and or other static storage device 926 coupled to bus 920 for storing static information and instructions used by processor 910.

A data storage device 927 such as a magnetic disk or optical disc and its corresponding drive may also be coupled to computer system 900 for storing information and instructions. Computer system 900 can also be coupled to a second I/O bus 950 via an I/O interface 930. A plurality of I/O devices may be coupled to I/O bus 950, including a display device 924, an input device (e.g., an alphanumeric input device 923 and or a cursor control device 922). The communication device 921 is for accessing other computers (servers or clients). The communication device 921 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. At least one computer readable medium having instructions stored thereon, which when executed by one or more processors, cause the processors to:
receive printing characteristic information at a printing system;
determine one or more dryer settings;
determine one or more dryer control parameters based on the printing characteristic information;
apply the one or more dryer control parameters to a dryer in the printing system;
perform a printing process at the printing system to apply marking material to a medium and dry the applied marking material via the dryer;
monitor the printing system during the printing and drying process to detect one or more printing characteristic information changes;
determine one or more updated dryer control parameters upon a detection of one or more printing characteristic information changes; and
apply the updated dryer control parameters to the dryer during the printing process.

2. The computer readable medium of claim 1, wherein the one or more dryer control parameters are determined based on the dryer settings.

3. The computer readable medium of claim 2, wherein a dryer setting comprises temperature.

4. The computer readable medium of claim 2, wherein a dryer setting comprises power.

5. The computer readable medium of claim 2, wherein a dryer setting comprises airflow.

6. A method comprising:
receiving printing characteristic information at a printing system;
determining one or more dryer settings;
determining one or more dryer control parameters based on the printing characteristic information;
applying the one or more dryer control parameters to a dryer in the printing system;
performing a printing process at the printing system to apply marking material to a medium and dry the applied marking material via the dryer;
monitoring the printing system during the printing and drying process to detect one or more printing characteristic information changes;
determining one or more updated dryer control parameters upon a detection of one or more printing characteristic information changes; and
applying the updated dryer control parameters to the dryer during the printing process.

7. The method of claim 6, further comprising determining the one or more dryer control parameters based on the dryer settings.

8. The method of claim 6, wherein a dryer setting comprises temperature.

9. The method of claim 6, wherein a dryer setting comprises power.

10. The method of claim 6, wherein a dryer setting comprises airflow.

11. A printing system, comprising:
a print controller; and
an engine controller to receive printing characteristic information from the print controller, determine one or more dryer settings, determine one or more dryer control parameters based on the printing characteristic information and update the one or more dryer control parameters upon detecting one or more printing characteristic information changes during a printing process.

12. The printing system of claim 11, wherein the engine controller determines one or more dryer settings prior to determining the one or more dryer control parameters.

13. The printing system of claim 12, wherein a dryer setting comprises temperature.

14. The printing system of claim 12, wherein a dryer setting comprises power.

15. The printing system of claim 12, wherein a dryer setting comprises airflow.

16. The printing system of claim 12 further comprising a print engine to apply marking material to a medium.

17. The printing system of claim 16, further comprising a dryer to dry the marking material applied to the medium according to the drying control parameters.
